(19) United States
(12) Patent Application Publication
(10) Pub. No.: US 2025/0312809 A1
(43) Pub. Date: Oct. 9, 2025

(54) APPLICATION DEVICE AND METHOD

(71) Applicant: Voith Patent GmbH, Heidenheim (DE)

(72) Inventor: Christoph Henninger, Heidenheim (DE)

(73) Assignee: Voith Patent GmbH, Heidenheim (DE)

(21) Appl. No.: 19/243,416

(22) Filed: Jun. 19, 2025

Related U.S. Application Data
(63) Continuation of application No. PCT/EP2023/081598, filed on Nov. 13, 2023.

(30) Foreign Application Priority Data
Dec. 21, 2022 (DE) 10 2022 134 304.9

(51) Int. Cl. B05B 15/555; B05B 13/02

(52) U.S. Cl. CPC B05B 15/555; B05B 13/0278

(57) ABSTRACT

An application device for applying a coating medium onto a moving surface includes an application head which extends over an entire width of the moving surface. A linear guide is provided which extends in a width direction of the application device parallel to the application head and which is provided for mounting one or a number of cleaning elements for the application head.

### CROSS REFERENCE TO RELATED APPLICATIONS

This is a continuation of International Patent Application No. PCT/EP2023/081598 entitled “APPLICATION DEVICE AND METHOD” filed on Nov. 13, 2023, which is incorporated in its entirety herein by reference. International Patent Application No. PCT/EP2023/081598 claims priority to German Patent Application No. 10 2022 134 304.9 filed on Dec. 21, 2022, which is incorporated in its entirety herein by reference.

### BACKGROUND OF THE INVENTION

### 1. Field of the Invention

The invention relates to an application device for applying a coating medium onto a moving surface and to a method for cleaning an application head.

### 2. Description of the Related Art

During production or processing of fibrous webs, such as paper or cardboard webs, a coating medium is often applied onto said webs, in order to influence for example, the surface properties, the permeability or the strength properties of the fibrous web.

Coating medium can either be applied directly onto the moving web or can be applied first onto a moving transfer surface (for example a transfer roll) and from there be transferred to the paper web.

There are a multitude of possibilities for the design of the application head from which the coating medium is dispensed.

An application head is known for example from DE 10 2016 209 336 A1 and DE 103 59 120 A1 from which the coating medium is dispensed from a slotted nozzle in the form of a free falling curtain onto the paper web or onto an application roller.

Publications DE 20 2017 100 655 U1 and DE 20 2015 009 603 U1 disclose application heads which apply the coasting medium by means of spray nozzles onto a moving surface.

The subsequently published patent application DE 102022105510 of the applicant discloses an application head which comprises a slotted nozzles and an air nozzle.

During the operation of these application heads, the application heads may become contaminated by the coating medium itself or by other impurities. For example, individual spray nozzles or individual areas or regions of the slotted nozzles may become clogged, thereby impairing application of the coating medium. Therefore, repetitive maintenance and cleaning of these application heads is imperative.

For cleaning curtain nozzles, DE 103 59 120 A1 suggests providing a closable opening on the front face of the nozzle.

It is also known from DE 20 2015 009 603 U1 to provide a second spray application device that has a multitude of spray nozzles for a spray application, so that one nozzle set is always in the application position, and the second nozzle set is in the maintenance or cleaning position.

Actual cleaning of these application heads, however, occurs entirely manually by use of a sponge, hose, or high pressure cleaner. This is, however, difficult and time-consuming and does not work or only works to a limited extent, especially in the narrow nozzle gap, if the application head is installed in the machine.

In regard to spray nozzles, the second set of nozzles must generally be removed from the machine to ensure thorough cleaning without interrupting machine operation over an extended period.

What is needed in the art is a way to facilitate improved cleaning of the application head and trouble-free operation of the application device. It is moreover needed to propose a flexible system which can be used for diverse types of application heads.

### SUMMARY OF THE INVENTION

An application device for applying a coating medium onto a moving surface is proposed, comprising an application head which extends over the entire width of the moving surface. In addition, a linear guide is provided which extends in width direction of the application device, and which is provided for mounting one or a number of cleaning elements for the application head.

The moving surface may be a material web, in particular a paper, cardboard or pulp web. Alternatively, the moving surface may also be a transfer surface, for example the surface of a transfer roll. From this transfer surface, the coating medium can be transferred onto a material web in a transfer nip.

The application head extending over the entire width of the moving web is to be considered as having been met if the application head extends at least over the particular part of the surface which is intended to be coated. In indirect application, for example, the transfer roll can be slightly wider than the material web that is to be coated later. In that case, an application head can also extend over just the width of the material web that is to be coated later. However, since these differences are in the magnitude of a few centimeters which-compared to the general widths of paper machines of approximately 10 m and more-barely carry weight, these linguistic differentiations are omitted in favor of simple readability and the terms “entire width” is used instead.

The coating media can for example be a starch solution, a pigment containing coating color or a barrier medium.

The linear guide can optionally be provided on the application head. Thereby it can be provided that the linear guide is attached to the application head. Alternatively, it can be provided that the application head itself is shaped such that it serves directly as linear guide. If the linear guide cannot or should not be attached directly to the application head, an equivalent solution is for the linear guide and the application head to be held by the same support device.

In some embodiments, it can be provided that the application device includes at least one cleaning element which is mounted on the linear guide and which is in particular mounted detachably.

Cleaning of the application heads in the machine, for example a paper machine is difficult for various reasons.

For one thing, these machine lines are very wide. Widths of 10m and more are common today. Thus, the areas of the application heads located in the center of the web are difficult to reach.

Furthermore, the available installation space is very limited. This applies to direct application wherein the application head must be positioned near the paper web, and also to indirect application since in this case, the transfer roll or transfer rolls take up a lot of space.

Moreover, the components and structures that are to be cleaned are relatively small, so that precise positioning of cleaning elements is essential.

The current invention solves these problems by providing a linear guide inside the application device. Like the application head, the linear guide extends in width direction of the moving surface. In some embodiments, the linear guide may extend parallel to the application head.

This guide can be constructed relatively compactly so that it can be inserted in the available installation space. A suitable cleaning element can be attached to this linear guide. If the cleaning element is detachably mounted the cleaning element should only be inserted into the machine at the time of cleaning and removed again once cleaning is complete.

It may be especially advantageous if the linear guide is arranged on the application head itself, as described above. This offers a number of advantages. For one thing, such a linear guide can easily be implemented and can also very easily retrofitted into existing lines.

Furthermore, mounting of the linear guide on the application head by simple means ensures that the relative position of the linear guide to the application head that is to be cleaned can be maintained very accurately.

In addition, the weight of the cleaning element is comparatively low, so that influencing of the positioning of the application head by a traversing cleaning element can be ruled out.

An average cleaning element, including drive, will weigh between 10 kg and 20 kg. Since a machine-wide application head will often weigh more than 100 kg/m and the support structures and cross members are designed to hold this weight in position, the additional weight of the cleaning element is not significant.

This design moreover eliminates the need for a separate cross member or bracket for the linear guide. The application device can thus be implemented very cost effectively.

If the linear guide cannot or should not be mounted directly on the application head, an equivalent solution is for the linear guide and the application head to be held by the same support device.

A number of cleaning elements can also be provided. It can be advantageous in particular, to provide diverse cleaning elements, which work in various locations or with different cleaning methods.

Because of this modular structure, application devices according to aspects of the invention can be used very flexibly.

In some embodiments, the at least one cleaning element can be movable along the linear guide. In this way it is possible to clean the entire width of the application head with a single, relatively compact cleaning element. Installation of a small movable cleaning element is also significantly easier to achieve than the installation of a machine-wide fixed cleaning element.

The cleaning element can be moved manually, by motorized means, pneumatically or hydraulically. The manual process is very easy and can be implemented inexpensively, for example by a cable pull. For basic cleaning elements, for example a sponge or something similar, which is swiped directly over the area to be cleaned, for example over the application head, this can certainly be sufficient. For more complex and heavier cleaning elements, for example cleaning elements with cleaning nozzles, an automatic or semi-automatic method may be preferred.

Provision may be made that the linear guide itself includes ways for moving the cleaning element. The cleaning element is then mounted on the movable unit. Thus, the cleaning element can be very simply retained. In particular, in the case of mechanical cleaning elements (for example sponge, film, etc.) this can be advantageous. Moreover, only one moving unit is required, even if a number of different cleaning elements are used.

Alternatively, the linear guide can be designed very simply, and can consist, for example, of only a bar, a rail or something similar. In that case, the ways for movement can be integrated into the cleaning element. This has the advantage that the linear guide can be designed to be simple and compact.

Besides, the components of the movable unit are installed in the machine only during the cleaning process, thus being able to avoid contamination of the movable unit during operation of the application device. This solution can be advantageous, in particular, on more complex cleaning devices, which comprise, for example, spray nozzles, etc.

Provision could be made for the application head to include a slotted nozzle, wherein the slot extends, in particular over the entire direction of the width of the cleaning device.

In the case of curtain application, or also in the case of the combined slot and air nozzle of DE102022105510 the slot width of the slotted nozzle is in particular in most cases less than 2 mm, in particular less than 1 mm.

Provision can be made alternatively, or in addition that the application head has one or a number of spray nozzles, wherein the number of spray nozzles are arranged, in particular, along the width direction of the application device.

Some embodiments may provide that the cleaning element includes ways for mechanical cleaning, in particular a cleansing film, a brush or a sponge.

The surface of an application head can be cleaned, in particular by using a sponge.

A brush is also used to clean the surface of the application head. If the brush is designed as a rotating brush, the cleaning effect can be enhanced.

Use of a cleansing film can be advantageous, in particular with slotted nozzles. Since the gap width of the slots on these wide slotted nozzles is very small, the risk of contamination is relatively high. For cleaning, a cleansing film can for example be introduced on the operator side of the nozzle gap and can then be moved along the width direction.

The cleansing films can consist, for example, of plastic, metal, carbon fiber reinforced polymer (CFK), glass reinforced polymer (GFK) or other suitable materials.

Since gap widths of <1 mm occur regularly, these cleansing films must be very thin but must nevertheless offer resistance. Therefore CFK- and GFK films are proposed, in particular. Compared with thin polymer films made of PVC, CFK films or respectively GFK films, just like metal films are dimensionally rather stable, so that they can be inserted more easily into the gap that is to be cleaned. Such dimensionally stable films can also be referred to as lamina. For better legibility, the term “film” within the scope of this application also includes such lamina.

Whereas the cleansing film itself represents a wear part, the predominant part of the cleaning element with the holding device for the film or the movable device is always reusable. The holder for the cleaning tool for quick changeover of cleansing films can be, for example, a clamp.

Alternatively, or in addition it may be provided that the cleaning element has one or a number of cleaning nozzles. It may be advantageous, in particular to provide two or three cleaning nozzles adjacent to one another.

These cleaning nozzles can be supplied with a cleaning fluid such as air, water, etc., which, if applicable, can be supplemented with surfactants or other cleaning agents.

Depending on adjustments and pressure, the cleaning fluid can herein also penetrate into the interior of the application head or can for example, also remove contaminants from inside the spray nozzles.

By moving individual cleaning nozzles along the linear guide, the entire width of the application head can be cleaned, without having to permanently install the cleaning medium lines in the installation space. After completion of cleaning, these lines, together with the other cleaning elements, can again be removed from the application device.

Provision can be made that the application head and the linear guide are permanently installed.

Alternatively, it may be provided that the application head can be moved, in particular pivoted, from a working position into a maintenance position. Cleaning can thus be conducted in in a more favorable position and, if necessary, areas of the application head can be reached that would be difficult or impossible to reach in the working position, for example due to insufficient distance from the transfer roller. This may be implemented, for example, as discussed in DE 20 2015 009 603 U1, in that a second spray application device with a multitude of spray nozzles is provided for a spray application, so that always one nozzle set is in the application position, and the second nozzle set is in the maintenance or cleaning position. However, other implementations are also possible.

Alternatively, or in addition it may also be provided that the linear guide can be moved, in particular pivoted, from a parking position into a maintenance position. The parking position can be selected, for example, so that the linear guide influences the production process as little as possible.

Some embodiments may provide that the cleaning element features an active and a passive state and that ways are provided to switch the cleaning element from the active into the passive state and/or from the passive into the active state.

One implementation of this feature can be that a mechanical cleaning element, such as a sponge, has no contact with the surface to be cleaned in the passive state. In the active state it is then placed, in particular pivoted against the surface to be cleaned.

One alternative implementation of this feature may be that a cleaning nozzle is not switched on in the passive state. By supplying a cleaning fluid, the nozzle is then switched into the active state. Other designs are also conceivable, subject to the cleaning element.

Such a design may offer the advantage that moving and repositioning of the cleaning element can be performed independently of the cleaning process. This enables targeted cleaning of individual areas in width direction. This reduces wear and tear of the cleaning element and consumption of cleaning agents.

For this purpose, it can be advantageous if a sensor, for example a high-resolution scanner, in particular with web inspection systems, is provided in process direction after the application device which can determine the position of the defect in the event of a fault, such as an uncovered strip in the fibrous web. The cleaning element can then be moved into exactly this location-optionally in the passive state—to eliminate the fault in a targeted manner.

Moreover, a method for cleaning an application head that is proposed, wherein the application head is provided in an application device according to one aspect of the invention, and wherein the method comprises the following steps:
a) mounting at least one cleaning element on the linear guide
b) moving the cleaning element in width direction of the application head along the linear guide.

It may therein be provided that the cleaning element is in the active state during movement along the linear guide. Thus, cleaning of the application head occurs during the entire movement process.

Alternatively, it may also be provided that the cleaning element is moved to a first position in the passive state, where the cleaning element is switched from the passive state into the active state. The cleaning element can then conduct targeted cleaning at this location. Subsequently, the cleaning element can then be moved, in particular, into a second position.

It may be advantageous if sensor means are provided in direction of web travel after the application device in order to determine a fault in the fibrous web, and the first position is determined on the basis of these sensor values. For example, a high-resolution scanner may be provided, especially withing the framework of a web inspection system, which detects a fault, for example an uncovered strip in the fibrous web and determines its position (as the first position).

The cleaning element can then-optionally in the passive state—be moved to this first position and can in this location conduct targeted cleaning of the application head. A variety of sensors can be suitable as sensor means. These could, for example, be sensors that determine the basis weight. Alternatively, they can also be gloss sensors that determine the gloss of the paper surface. Frequently, camera based optical sensors are also used. It is, however, also possible to detect a contaminated location because individual thicker or thinner areas occur at the winder. This list of possible sensor means can be further expanded.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a side view of an exemplary application device provided according to one aspect of the invention;

FIG. 2 is a side view of an exemplary application device provided according to another aspect of the invention;

FIGS. 3A and 3B are side views of an exemplary application device provided according to additional aspects of the invention;

FIG. 4 is a side view of an application device that is known from the state of the art;

FIG. 5 is a side view of an exemplary application device provided according to one aspect of the invention; and

FIG. 6 is a side view of an exemplary film press provided according to one aspect of the current invention.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

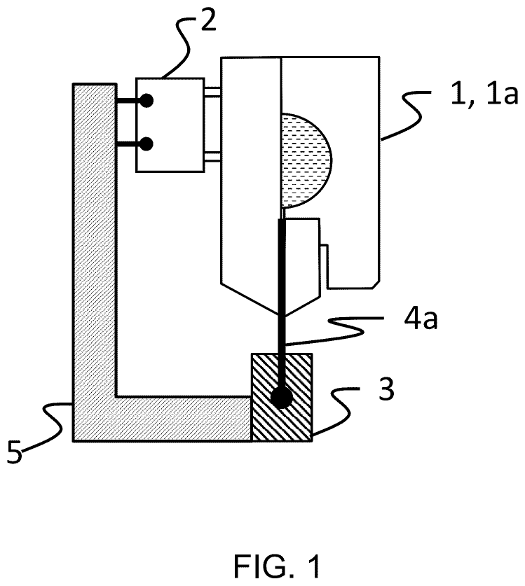

Referring now to the drawings, FIG. 1 shows a side view of an application device provided according to one aspect of the current invention. Application head 1 is herein designed as a slotted nozzle of a curtain application device which extends into the plane of the web over the entire width of moving surface 10. Application head 1 is herein connected via a mounting which is not illustrated, and which is connected with the machine frame. Furthermore, a linear guide 2 is provided, which also extends in width direction. In the embodiment shown here, linear guide 2 is attached directly to application head 1 and extends parallel to the latter.

FIG. 1 also shows a cleaning element 3 for cleaning application head 1. In this case, cleaning occurs mechanically by using a cleansing film 4a, which is introduced into the nozzle gap of application head 1. If cleaning element 3 is moved along linear guide 2, cleansing film 4a is pulled through the nozzle gap and can thus remove contaminations from the gap. Since common gap widths are <1 mm, cleansing films 4a should be very thin, should however offer resistance. Therefore, comparatively dimensionally stable CFK and GFK films are particularly recommended here.

Also, a mounting 5 is provided. Mounting 5 can be part of cleaning element 3 and can be easily removed and installed with the latter. Alternatively, mounting 5 can also be separated from cleaning element 3 so that only the holder of cleansing film 4a is removed from the machine—for example for changing over cleansing film 4a-whereas mounting 5 remains permanently in the machine.

Moving of cleaning element 3 along the linear guide can occur in diverse ways. One possibility is a manual repositioning by a cable pull or a crank. However, this is only practical with narrower machines. The movement is normally accomplished by motor, pneumatically or hydraulically. The means to move the cleaning device can be accommodated in the linear guide. Alternatively, means for movement—for example, a drive motor—can be accommodated in cleaning element 3 itself, or in mounting 5.

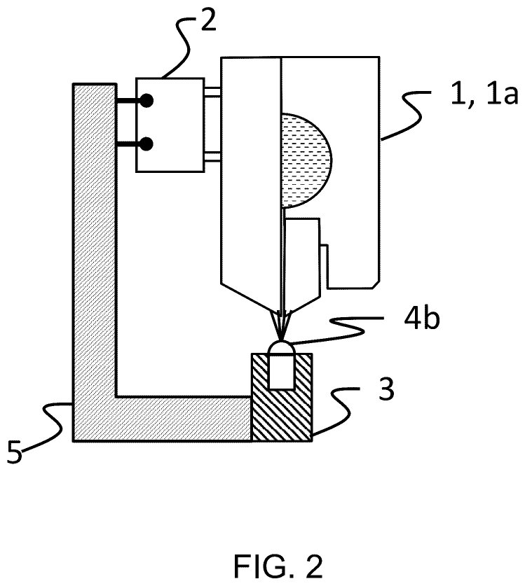

The embodiment illustrated in FIG. 2 differs from that in FIG. 1 in that one or a number of cleaning nozzles 4b are provided instead of mechanical cleaning by cleansing film 4a. It can be advantageous, in particular, to provide two cleaning nozzles 4b adjacent to one another. It is also possible that cleansing films 4a and cleaning nozzles 4b are used together in one cleaning element 3.

The embodiment in FIG. 2 may also be particularly advantageous if application head 1 is equipped with a spray nozzle instead of a slotted nozzle 1a.

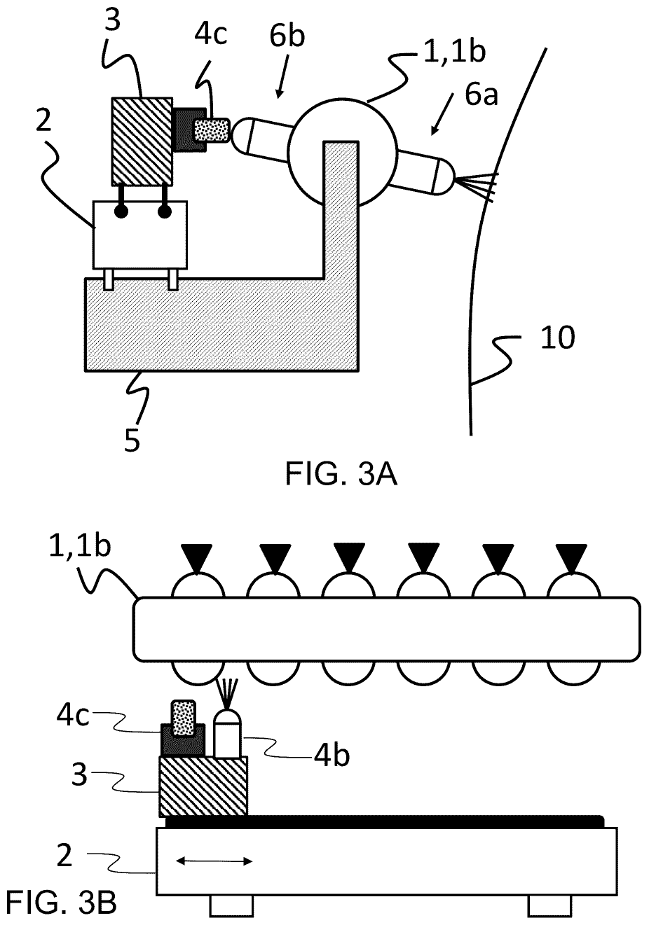

FIGS. 3A and 3B show additional application devices according to aspects of the invention. As known from DE 20 2015 009 603 U1, application head 1 is equipped with two sets of spray nozzles 1b for application of the coating medium onto a moving surface 10. While one set of spray nozzles 1b is in the working position 6a, the second set of spray nozzles 1b is in a maintenance or cleaning position 6b.

A linear guide 2, extending in width direction of the application device is also provided here. Linear guide 2 is mounted on application head 1 or respectively, application head 1 and linear guide 2 are supported by the same support mounting 5.

Moreover, a cleaning element 3 is provided which is mounted on linear guide 2 and which is mounted, in particular, detachably. Linear guide 2 and cleaning element 3 are therein mounted in such a way that spray nozzles 1b can be cleaned in cleaning position 6b, while the application device can continue to operate with the remaining spray nozzles in working position 6a.

In the device illustrated in FIG. 3A, a cleaning sponge 4c is provided for cleaning. This can be advantageous because, in contrast to cleaning with cleaning nozzles 4b, no spray mist is created which could impair ongoing operation of the application device.

A variation of this device is shown in FIG. 3B. In contrast to FIG. 3A, cleaning element 3 includes a cleaning sponge 4c and a cleaning nozzle 4b. It can be provided therein that cleaning nozzle 4b as well as cleaning sponge 4c are active, while the cleaning element is moved along the linear guide. However, provision can also be made that cleaning nozzle 4b and/or cleaning sponge 4c are in the passive state until cleaning element 3 is moved into a first position. This may, for example, be a heavily contaminated spray nozzle 1b. Then, switching over from the passive to the active state can occur, so that in particular, cleaning nozzle 4b is active as a result of supplying cleaning fluid and thus cleans contaminated spray nozzle 1b or the contaminated part of application head 1 in a targeted manner.

It may be advantageous here if a suitable sensor is provided in the process direction after the application unit which can detect the location of the contamination via the resulting fault in the paper web and transmit this to a control system of cleaning element 3.

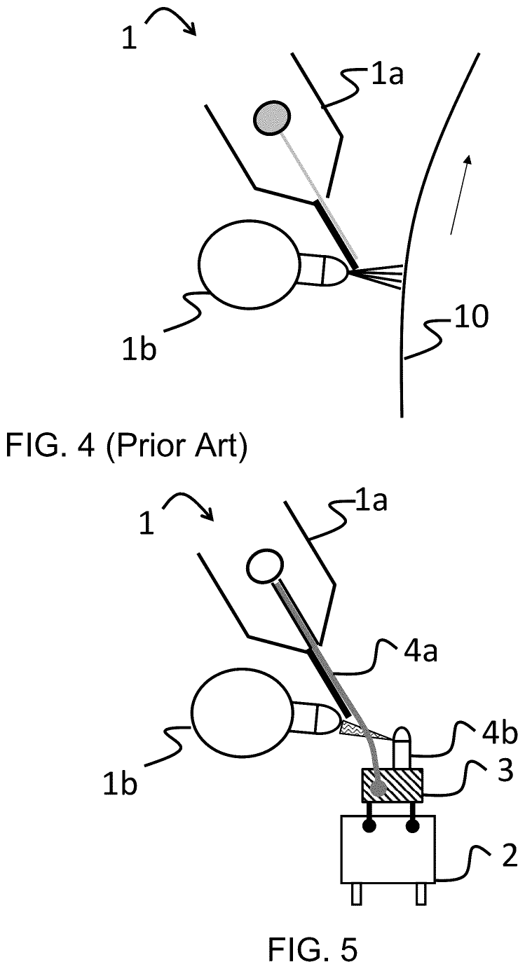

FIG. 4 illustrates an application device, as known from the state of the art, in particular as known from DE 102022105510. Application head 1 therein includes a slotted nozzle 1a from which the coating medium is dispensed, as well as a spray nozzle 1b. Spray nozzle 1b is pressurized with air so that the coating medium that is dispensed by slotted nozzle 1a across the width of the machine is deposited on moving surface 10 as a spray mist.

With this application head 1, slotted nozzle 1a as well as spray nozzle 1b can become contaminated. Simple and reliable cleaning of nozzles 1a, 1b is therefore especially advantageous.

FIG. 5 illustrates a further development of the device shown in FIG. 4, according to one aspect of the invention. A linear guide 2 is again provided to accommodate a cleaning element 3. Since the distance between air nozzle 1b and moving surface 10 is usually kept very small, designs wherein linear guide 2 and/or spray nozzle 1b and/or slotted nozzle 1a can be moved, in particular pivoted into a maintenance or cleaning position are hereby often especially advantageous.

In the design illustrated in FIG. 5, cleaning element 3 includes a cleansing film 4a for cleaning slotted nozzle 1a, as well as a cleaning nozzle 4b for cleaning spray nozzle 1b. Various other designs are also conceivable. A cleaning nozzle 4b may also be provided for cleaning slotted nozzle 1a. A single cleaning nozzle 4b may, for example, also be provided, the spray direction of which is adjusted or can be adjusted so that it can be used for cleaning spray nozzle 1b as well as slotted nozzle 1a.

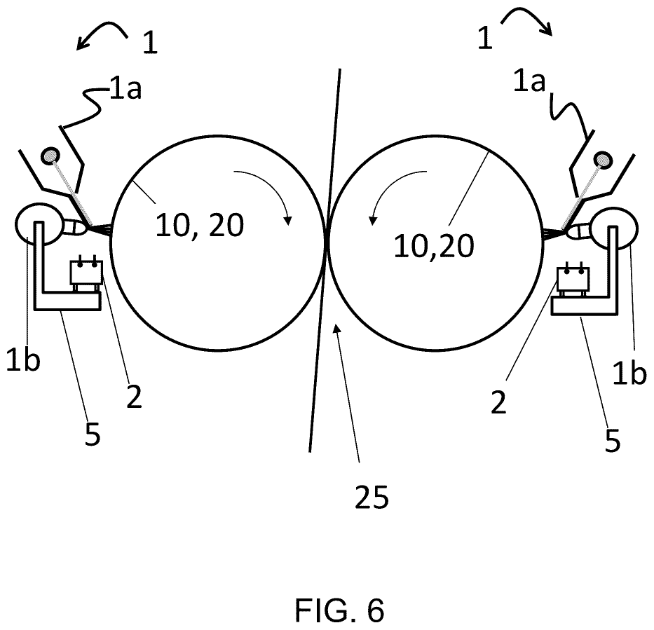

FIG. 6 shows a size press for double sided application of a starch solution onto a fibrous web. Two transfer rolls 20 are provided which are arranged so that they form a transfer nip 25 in which the starch solution is transferred from the surface of transfer rolls 10, 20 to a paper or cardboard web. An application head 1 is provided on each of the transfer rolls, which analogous to FIG. 4 includes a slotted nozzle 1a and a spray nozzle 1b. Alternatively, a clean slotted nozzle 1a or a clean spray nozzle 1b could be provided.

In order to ensure good penetration of the starch solution into the fibrous web, it can be advantageous if both transfer rolls 20 are provided with a hard surface. The hardness of the roll surface can therein be in particular greater than 50 ShoreD or even greater than 60 ShoreD.

In the film press, a linear guide 2 is provided for each application head 1. It may therein be particularly advantageous if the two linear guides 2 are of the same design. This makes it possible, for example, to clean both application heads 1 with a single cleaning element 3. This may be especially advantageous if cleaning element 3 is very complex and includes, for example, its own drive and/or devices to supply cleaning nozzles 4b with cleaning fluid.

In the design illustrated in FIG. 6, linear guide 2 is mounted in each case on spray nozzle 1b, or both share a common mounting 5. Alternatively, or in addition it may, for example, also be provided that linear guide 2 is provided on slotted nozzle 1a.

Depending on the application it may also be advantageous if a linear guide 2 is provided on spray nozzle 1b as well as on slotted nozzle 1a. Thus, a cleaning element 3 could be provided for each slotted nozzle 1a and spray nozzle 1b, which could clean the respective part of application head 1, independently of each other.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

### Component Identification Listing

1 application head
1a slotted nozzle
1b spray nozzle
2 linear guide
3 cleaning element
4a cleansing film
4b cleaning nozzle
4c cleaning sponge
5 mounting
6a working position
6b cleaning position
10 moving surface
20 transfer roll
25 transfer nip

What is claimed is:

1. An application device for applying a coating medium onto a moving surface, comprising:
an application head which extends over an entire width of the moving surface and includes a slotted nozzle; and
a linear guide which extends in a width direction of the application device parallel to the application head and which is provided for mounting one or more cleaning elements for the application head.

2. The application device of claim 1, wherein a slot width of the slotted nozzle is less than 2 mm.

3. The application device of claim 1, wherein the linear guide is provided on the application head or the linear guide and the application head are held by a same support device.

4. The application device of claim 1, wherein the application device comprises at least one cleaning element which is mounted detachably on the linear guide.

5. The application device of claim 4, wherein the at least one cleaning element comprises a cleansing film.

6. The application device of claim 5, wherein the cleansing film is a carbon fiber reinforced polymer (CFK) film or a glass reinforced polymer (GFK) film.

7. The application device of claim 4, wherein the at least one cleaning element is designed to be movable along the linear guide, and wherein the cleaning element can be moved manually, by motorized means, pneumatically, or hydraulically.

8. The application device of claim 4, wherein the at least one cleaning element includes a sponge or a brush for mechanical cleaning.

9. The application device of claim 4, wherein the at least one cleaning element has one or a number of cleaning nozzles.

10. The application device of claim 4, wherein the at least one cleaning element features an active state and a passive state and that means are provided to switch the at least one cleaning element from the active state into the passive state and/or from the passive state into the active state.

11. The application device of claim 1, wherein the application head has one or a number of spray nozzles, wherein the number of spray nozzles are arranged along the width direction of the application device.

12. The application device of claim 1, wherein the application head can be moved from a working position into a maintenance position, and/or the linear guide can be moved from a parking position into a maintenance position.

13. The application device of claim 12, wherein the application head can be pivoted from the working position into the maintenance position, and/or the linear guide can be pivoted from the parking position into the maintenance position.

14. The application device of claim 1, wherein the application device has a first application head which has assigned to it a first linear guide and a second application head which has assigned to it a second linear guide, and wherein the application device moreover has a cleaning element which can be mounted alternatively on the first linear guide and on the second linear guide.

15. A method for cleaning an application head of an application device for applying a coating medium onto a moving surface, the application device comprising the application head which extends over an entire width of the moving surface and includes a slotted nozzle and a linear guide which extends in a width direction of the application device parallel to the application head and which is provided for mounting one or more cleaning elements for the application head, the method comprising:
mounting at least one cleaning element on the linear guide; and
moving the at least one cleaning element in the width direction of the application head along the linear guide.

16. The method of claim 15, wherein the at least one cleaning element is in an active state during movement along the linear guide.

17. The method of claim 15, wherein the at least one cleaning element is moved to a first position in a passive state, wherein the at least one cleaning element is switched from the passive state into an active state.

18. The method of claim 17, wherein sensor means are provided in a direction of web travel after the application device in order to determine a fault in a fibrous web, and the first position is determined on the basis of sensor values from the sensor means.
